(19) United States
(12) Patent Application Publication
(10) Pub. No.: US 2015/0180749 A1
(43) Pub. Date: Jun. 25, 2015

(54) APPARATUS AND METHOD FOR MAPPING POSITION INFORMATION OF VIRTUAL RESOURCES

(71) Applicant: KOREA ELECTRONICS TECHNOLOGY INSTITUTE, SEONGNAM-SI (KR)

(72) Inventors: Jong Bin PARK, Gyeonggi-do (KR); Tae Beom LIM, Gyeonggi-do (KR); Kyung Won KIM, Seoul (KR); Jae Won MOON, Seoul (KR); Seung Woo KUM, Gyeonggi-do (KR); Jong Jin JUNG, Seoul (KR)

(73) Assignee: KOREA ELECTRONICS TECHNOLOGY INSTITUTE, SEONGNAM-SI (KR)

(21) Appl. No.: 14/551,261

(22) Filed: Nov. 24, 2014

(30) Foreign Application Priority Data
Dec. 24, 2013 (KR) 10-2013-0162211

(51) Int. Cl. H04L 12/26; G06F 9/455; H04L 12/911

(52) U.S. Cl. CPC H04L 43/08; H04L 47/70; G06F 9/455

(57) ABSTRACT

Provided is a method for automatically obtaining position information of virtual resources such as a network device in a virtual space such as a house, an office, and the like. The method for mapping position information of a virtual resource includes recognizing virtual resources virtualized according to services or characteristics unique to devices in a particular space, and collecting virtual resource information including internal states and providing services of the virtual resources, obtaining event occurrence information regarding the virtual resources by using the virtual resource information, when an event occurs in at least any one among the virtual resources, obtaining image information regarding the particular space, and obtaining position information regarding the virtual resources by using the event occurrence information and the image information.

### CROSS-REFERENCE TO RELATED APPLICATIONS

This application claims priority under 35 U.S.C. §119 to Korean Patent Application No. 10-2013-0162211, filed on Dec. 24, 2013, the disclosure of which is incorporated herein by reference in its entirety.

### TECHNICAL FIELD

The present invention relates to a method and apparatus for mapping position information of virtual resources, and more particularly, to a method for automatically obtaining position information of virtual resources such as a network device in a virtual space such as a house, an office, and the like.

### BACKGROUND

Recently, IT devices are available to share information between heterogeneous devices via a network. For example, content items and provide services may be shared by devices connected via a network by using a universal plug and play (UPnP) technique.

However, such interworking is based on a logical connection via a network, having a limitation in that a physical position in a space is not taken into consideration. If position information of virtual resources or objects is used in a space, cooperative services may be provided between devices and it may also be utilized to search for positions of virtual resources and objects.

Namely, in order to provide such services, physical position information in which virtual resources and objects exist should be mapped with logical information. Mapping of position information may be manually input by users directly; however it is very cumbersome and not practical in a case in which devices are increased in number and positions thereof are frequently changed.

Virtual resource may be defined as devices virtualized according to unique services or characteristics thereof in a specific space, and here, for example, if a single physical device has one or more services or unique characteristics, it may be regarded as including several virtual resources. Conversely, several physical devices may also configure a single virtual resource. A person, a legacy device, a sculpture, an article, and the like, may be defined as an object, and a virtual resource and an object may be distinguished whether a provided service has capabilities of interworking with other device based on a particular protocol. The use of physical positions of resources or objects is advantageous in that devices can be cooperatively controlled as well as being independently controlled.

Existing patents (Registration Nos. 10-0818171, 10-0575447, 10-1071118, etc.) propose apparatuses and methods for searching for positions of existing virtual resources or physical objects or mapping logical information and physical position information in consideration of the foregoing environment. However, the existing mapping methods require a process in which users should intentionally recognize physical position information of devices and manipulate icons, or the like. Also, the existing mapping methods require an additional hardware component such as a remote controller in order to track a position of an object within a house, having a limitation in that the methods cannot be applied to existing devices.

### SUMMARY

Accordingly, the present invention provides a method and apparatus for mapping logical information expressing virtual resources and physical position information regarding physical positions at which devices constituting the virtual resources are actually placed, by minimizing a process of intentionally inputting the information by a user.

The object of the present invention is not limited to the aforesaid, but other objects not described herein will be clearly understood by those skilled in the art from descriptions below.

In one general aspect, a method for mapping position information of a virtual resource includes: recognizing virtual resources virtualized according to services or characteristics unique to devices in a particular space, and collecting virtual resource information including internal states and providing services of the virtual resources; obtaining event occurrence information regarding the virtual resources by using the virtual resource information; when an event occurs in at least any one among the virtual resources, obtaining image information regarding the particular space; and obtaining position information regarding the virtual resources by using the event occurrence information and the image information.

In another general aspect, an apparatus for mapping position information of a virtual resource includes: a virtual resource recognizing and state information collecting unit configured to recognize virtual resources virtualized according to services or characteristics unique to devices in a particular space, and collect virtual resource information including internal states and providing services of the virtual resources; a space monitoring unit configured to obtain image information regarding the particular space when an event occurs in at least any one among the virtual resources; and an information processing unit configured to obtain event occurrence information regarding the virtual resources by using the virtual resource information, and obtain position information regarding the virtual resources by using the event occurrence information and the image information.

Other features and aspects will be apparent from the following detailed description, the drawings, and the claims.

### BRIEF DESCRIPTION OF THE DRAWINGS

FIG. 1 is a view illustrating a configuration of an apparatus for mapping position information of a virtual resource according to an embodiment of the present invention.

FIG. 2 is a view illustrating an example of a monitored image input through a space monitoring unit of FIG. 1.

FIG. 3 is a view illustrating a method of mapping position information of virtual resource according to an embodiment of the present invention.

FIG. 4 is a view illustrating an object extracting method according to an embodiment of the present invention.

FIG. 5 is a view illustrating an example of obtaining position information by an apparatus for mapping position information of virtual resource according to an embodiment of the present invention.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail with reference to the accompanying drawings. In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

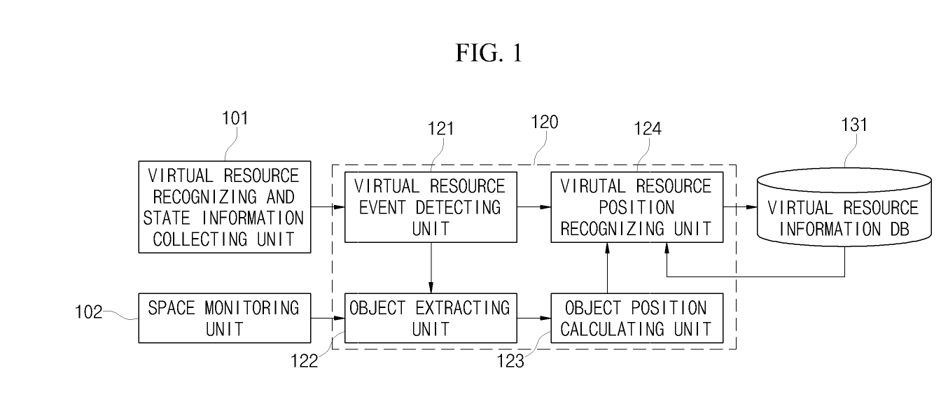

FIG. 1 is a view illustrating a configuration of an apparatus for mapping position information of a virtual resource according to an embodiment of the present invention.

Referring to FIG. 1, an apparatus for mapping position information of a virtual resource according to an embodiment of the present invention includes a virtual resource recognizing and state information collecting unit 101, a space monitoring unit 102, an information processing unit 120, and a virtual resource information DB 131.

All the components of the apparatus for mapping position information of a virtual resource according to an embodiment of the present invention may be positioned in a space such as a house or an office, or the information processing unit 120 and the virtual resource information DB 131 may be positioned in a remote area connected to a network in consideration of a distributed computing environment.

Here, virtual resource may be defined as devices virtualized according to unique services or characteristics thereof in a specific space. For example, if a single physical device has one or more services or unique characteristics, it may be regarded as including several virtual resources. Conversely, there may be a situation in which a single virtual resource is dividedly present in several locations physically. In a practical example, a lamp, a TV, an audio set, and a printer may be independent virtual resources, respectively, but these may be grouped into units such as {lamp+audio set}, {lamp+audio set+TV+printer}, and the like, to cooperatively support services, and here, each unit may be a virtual resource.

An object may be defined as a person, a legacy device, a sculpture, an article, and the like, in a space, and a virtual resource and an object may be distinguished whether a provided service has capabilities of interworking with other device based on a particular protocol. The use of physical positions of resources or objects is advantageous in that devices can be cooperatively controlled as well as being independently controlled.

The virtual resource recognizing and state information collecting unit 101 recognizes virtual resources present in a specific space to collect internal states of the current virtual resources, provided service information, and the like. Also, the virtual resource recognizing and state information collecting unit 101 provides functions that may be able to deliver recognized information to other device connected to an internal or external network.

To this end, the virtual resource recognizing and state information collecting unit 101 and the virtual resources are connected via a network by using an arranged communication protocol. For example, universal plug and play (UPnP) is one of communication protocols therefor.

UPnP refers to an aggregation of communication protocols enabling content or services provided by virtual resources to be easily shared and controlled. Virtual resources supporting UPnP may be easily recognized by other devices within a network, share content, and control each other or be controlled by each other. The UPnP protocol is described as an example supporting a network connection between virtual resources or between virtual resources and the virtual resource recognizing and state information collecting unit 101, and the present invention is not limited thereto. For example, a method of synchronously or asynchronously collecting state information by using a network architecture such as representational state transfer (REST), an inter-device communication method using message passing interface (MPI), ZigBee™, Bluetooth™, and the like, or a method of registering virtual resource information directly by a user, and the like, may be used. Of course, most preferably, it is configured such that virtual resources connected to a network are automatically recognized by minimizing a process of registering information intentionally by a user and state information of each virtual resource is continuously collected and managed.

The virtual resource information collected by the virtual resource recognizing and state information collecting unit 101 has a limitation in that it cannot provide physical position information such as a position in which a virtual resource is placed in a space.

The reason why a physical position of a virtual resource is important is because the position information can be utilized to control devices by intuition, provide device-cooperative services, and search for positions of virtual resources. Mapping of position information may be manually input by users directly; however it is very cumbersome and not practical in a case in which devices are increased in number and positions thereof are frequently changed.

To solve the problem, in the present invention, the space monitoring unit 102 is provided. The space monitoring unit 102 serves to synchronously and asynchronously monitor an event that occurs or a change that is made in a space such as a house or an office, for which it is desirable to configure a single or N number of cameras that may be connected to a network and perform monitoring in terms of effectively collecting information.

For example, cameras for monitoring space information generally uses an image sensor for converting an optical signal into an electrical signal, such as charge-coupled device (CCD) a complementary metal-oxide semiconductor (CMOS), but it would be more effective to use RGB/depth camera or a depth camera that may be able to directly or indirectly extract depth information from a camera to an object.

The use of both image information and depth information facilitates obtaining even 3D space information (depth information) as well as extracting several objects in a space observed at an angle of view of a camera. In addition, when depth information is used, skeleton and gesture information of a human body can be more rapidly and accurately obtained than in using only 2D image information.

In order to obtain depth information, for example, a method of converting a time taken for pulse light, after being output, to be reflected from an object and returned, into a distance, an active method of projecting structured light having a particular pattern to a subject, capturing an image, and estimating a distance by using triangulation, and the like, may be used. However, with general imaging cameras, depth information may also be estimated by using input images and intrinsic and extrinsic camera parameter information. In general, after images are obtained with two or more cameras physically separated in a space, feature points may be matched, and with respect to the matched points, an absolute distance may be calculated with intrinsic and extrinsic camera parameter information by using triangulation.

The information processing unit 120 performs a process of obtaining position information regarding virtual resources by using virtual resource information. The information processing unit 120 includes a virtual resource event detecting unit 121, an object extracting unit 122, an object position calculating unit 123, and a virtual resource position recognizing unit 124.

When a state of virtual resources is changed based on virtual resource information recognized by the virtual resource recognizing and state information collecting unit 101, the virtual resource event detecting unit 121 determines it as an event.

For example, it is assumed that a volume, a channel, and the like, is changed in a smart TV which supports UPnP, which is designed with REST architecture, or which has an application program or a protocol for the virtual resource event detecting unit 121.

Here, the virtual resource event detecting unit 121 may sense that internal state information of a particular virtual resource called a smart TV has been changed, and determines it as event information. The detected event information may include information of the virtual resource which has generated the event, a time at which the event has occurred, and a type of the generated event, and the object extracting unit 123 may synthetically utilized the information.

When the virtual resource event detecting unit 121 detects the particular event, the object extracting unit 122 extracts a candidate object determined to be a virtual resource that has generated the event upon receiving an image or depth information obtained from the space monitoring unit 102.

Here, space monitoring information (e.g., image information, depth information, etc.) may be obtained from the space monitoring unit 102 in real time when an event occurs in a virtual resource.

On the other hand, time-synchronized time stamp information may be included in the space monitoring information obtained from the space monitoring unit 102 and subsequently stored in a temporary buffer or a repository, and may be processed after the lapse of a time to a degree.

For example, it is assumed that space monitoring image information is obtained through the space monitoring unit 102.

The object extracting unit 122 detects candidate objects including feature elements anticipated to have generated the event from the obtained monitoring information, and outputs the detected candidate objects. In the present invention, in order to detect the candidate objects, two methods, namely, (1) a method of using an image region changing with the passage of time and (2) a method of analyzing a signal included in an image, are used.

As an example of expressing a region occupied by the detected candidate objects occupy in the image, a method of expressing position information of every pixel included in an object, in the form of aggregation may be used.

In another example, image may be discriminated in the form of lattice or a honeycomb, and regions occupied by the candidate objects in the image may be expressed by using indices of the cells.

In another example, regions occupied by the candidate objects in the image may be expressed by using a circular shape, a rectangular shape, a polygonal shape, and the like, including an object.

In an example of detecting an object in actuality, it is assumed that the virtual resource event detecting unit 121 detects an event of “Smart TV is turned on.” Then, brightness or a color is highly likely to be changed in a region related to the TV with the passage of time, and here, it is very natural that the region is determined as a candidate region. Namely, candidate objects may be detected by regarding a region in which image information is changed in a time axis, as feature elements. In a specific example, regions in which a foreground, a background, a global/local brightness, movement, and the like, have occurred may be detected as candidate objects.

However, a change may rarely be made in a monitoring image with the passage of time. In a specific relevant example, when an event “Smart TV is turned up” occurs, since the volume of a sound is changed, it may be difficult to find out a characteristic change only with image information.

In such a case, candidate objects are detected by using even feature elements existing in an image signal together. Examples of feature elements existing in an image may include various levels of objects such as a static region, a complicated region, a person and an article, a physical region such as a face of a person, eyes, nose, mouth, an object region such as vessel, a frame, and the like.

In order to detect an object including such feature elements, object detecting methods using a clustering technique and machine learning methods may be utilized. Here, space frequency characteristics of an image signal, uniformity, continuity, color information, depth information, and the like, may be utilized. The method of detecting an object using a machine learning method may be, for example, Haar classifier. The Haar classifier is frequently used to recognize a face object, but it may also be applied to various objects through repeated training with respect to intended learning target objects. Based on learned information, when new testing data is input, the Haar classifier may determine whether the new testing data is an already learned target object. Namely, the Haar classifier provides a means for determining whether an object exists or a position of an object in a still image at a particular point in time.

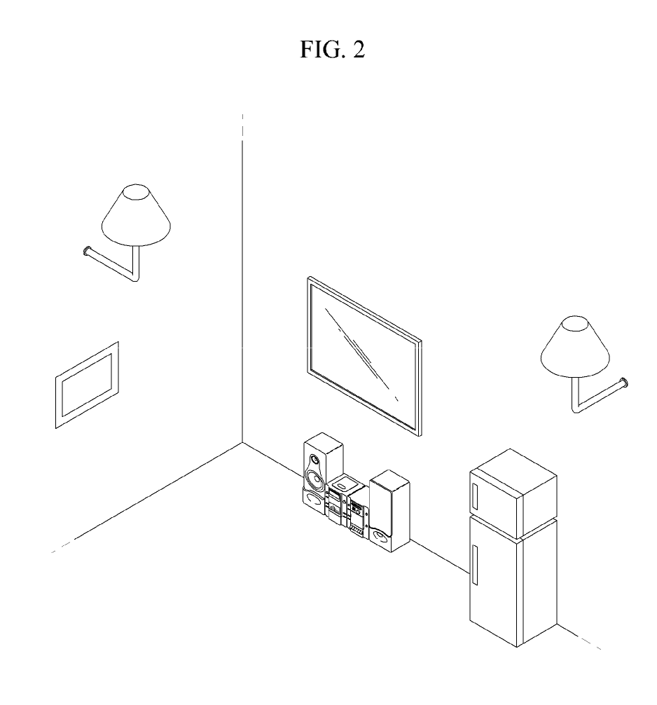

A method of detecting an object according to each event situation by the object extracting unit 122 will be described with reference to FIG. 2.

When the virtual resource event detecting unit 121 detects an event “Smart TV is turned on,” first, the object extracting unit 122 checks whether a region has been changed in a monitored image. When a region has been changed, the corresponding region is detected as a candidate object. The object extracting unit 122 detects an additional candidate object through the Haar classifier or a feature point analyzing algorithm by using feature elements based on which “Smart TV” may be identified.

On the other hand, even though it is detected that an event has occurred, if a significant change or feature is not observed in the space monitoring information, the object extracting unit 122 may directly control virtual resources (e.g., active controlling such as turning off or on the TV, turning on or off the lamp, controlling the audio set, and the like), and when a significant change is made, the object extracting unit 122 may detect a candidate object by using the change.

The object position calculating unit 123 calculates position information of each of the candidate objects output by the object extracting unit 122 in a 3D space. As described above with respect to the space monitoring unit 102, when 3D depth information is available, it may be used as the position information, and if 3D depth information is not directly available, position information may be estimated by performing an additional calculation. Here, the position information may be expressed by rectangular coordinate system, Cartesian coordinate system) or a polar coordinate system. The information may be expressed by selectively using an appropriate coordinate system. For example, when the space monitoring unit 102 is monitoring a hexahedral space by using an RGB-depth camera, preferably, 3D position information of each object is expressed in the form of the rectangular coordinate system by using an image and depth information output from the camera. If the space monitoring unit 102 includes two or more cameras, 3D position information of objects extracted by each camera may be obtained by utilizing techniques such as stereo-matching, multiview matching, and the like. If only a single imaging camera is used, it may be difficult to obtain depth information. In this case, positions of objects are expressed with angle information such as up/down/left and right angles without consideration of depth information to an object in the camera by using a polar coordinate system such as a 3D spherical coordinate system.

After calculating position information of each candidate object, the virtual resource position recognizing unit 124 removes candidate objects determined to have a logical error in consideration of (1) objects, (2) position information of objects, (3) characteristics of the virtual resource which has generated an event, (4) a type of event which has been generated by the virtual resource, and the like, together, and determines candidate positions of the virtual resource. For example, if it is determined that a TV or a refrigerator floats with supports, if a stationary virtual resource which cannot move by itself has been significantly changed in position over time or a size thereof has been significantly changed to be greater than a threshold value over time, the virtual resource position recognizing unit 124 removes such a situation to enhance accuracy. To this end, information stored in the virtual resource information DB 131 may be utilized in the form of feedback.

The determined position information of the candidate objects is regarded as a candidate position of a virtual resource and stored in the virtual resource information DB 131. Here, a plurality of candidate positions may be mapped to a single virtual resource. Also, if there is no candidate object or if there is no position information of candidate objects, a candidate position of a virtual resource may not be recognized. However, when an event occurs repeatedly in a virtual resource, the same calculation process may be performed again, thus improving accuracy of position information with reference to the stored virtual resource information DB 131. In the present invention, in order to improve position accuracy, methods of using statistical filter tools such as Kalman filter or a particle filter are proposed as a specific method of using the already secured virtual resource information DB 131.

The information processing unit 120 and the virtual resource information DB 131 may not be present in a location physically in close proximity to the virtual resource recognizing and state information collecting unit 101 and the space monitoring unit 102. In general, in order to simultaneously process state information of a virtual resource and monitored space information, a calculation resource having high specifications is required. Also, since collected information regarding virtual resources needs to be stably managed, the information processing unit 120 and the virtual resource information DB 131 may be placed in a remote location connected to a network in order to technically manage the information.

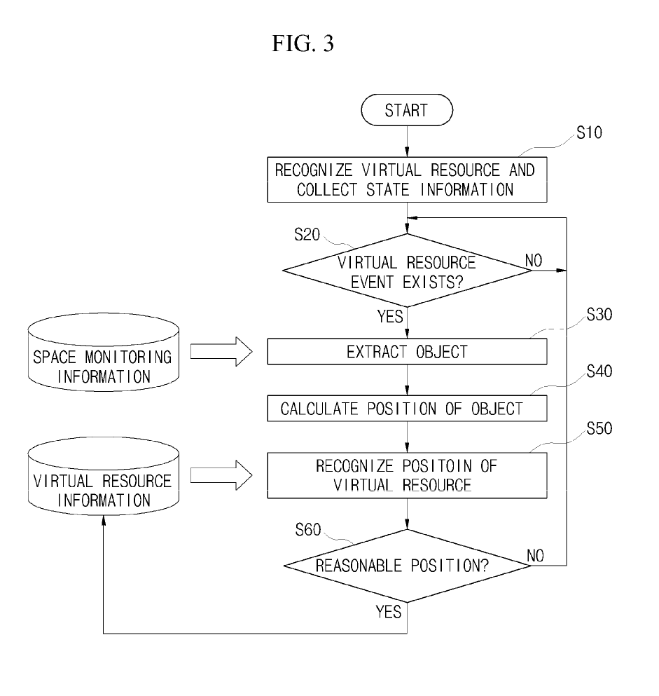

So far, the configuration of the apparatus for mapping position information of a virtual resource according to an embodiment of the present invention has been described. Hereinafter, an operation of the apparatus for mapping position information of a virtual resource according to an embodiment of the present invention will be described with reference to FIGS. 3 through 5.

FIG. 3 is a view illustrating a method of mapping position information of a virtual resource according to an embodiment of the present invention.

In step S10, the virtual resource recognizing and state information collecting unit 101 recognizes virtual resources existing in a particular space and collects internal states, providing service information, and the like, of the current virtual resources.

To this end, the virtual resource recognizing and state information collecting unit 101 and virtual resources are connected by a network by using an arranged communication protocol. For example, universal plug and play (UPnP) is one of communication protocols therefor. UPnP refers to an aggregation of communication protocols enabling content or services provided by virtual resources to be easily shared and controlled. Virtual resources supporting UPnP may be easily recognized by other devices within a network, share content, and control each other or be controlled by each other. The UPnP protocol is described as an example supporting a network connection between virtual resources or between virtual resources and the virtual resource recognizing and state information collecting unit 101, and the present invention is not limited thereto.

Preferably, the virtual resource recognizing and state information collecting unit 101 is configured to automatically recognize virtual resources connected to a network and continuously collect and manage state information or each virtual resource.

In step S20, when a state of virtual resources is changed based on virtual resource information recognized by the virtual resource recognizing and state information collecting unit 101, the virtual resource event detecting unit 121 determines it as an event.

For example, it is assumed that a volume, a channel, and the like, is changed in a smart TV. Here, the virtual resource event detecting unit 121 may sense that internal state information of a particular virtual resource called a smart TV has been changed, and determines it as event information. The detected event information may include information of the virtual resource which has generated the event, a time at which the event has occurred, and a type of the generated event, and the object extracting unit 123 may synthetically utilized the information.

In step S30, when the virtual resource event detecting unit 121 detects the particular event, the object extracting unit 122 extracts a candidate object determined to be a virtual resource that has generated the event upon receiving an image or depth information obtained from the space monitoring unit 102.

Here, space monitoring information (e.g., image information, depth information, etc.) may be obtained from the space monitoring unit 102 in real time when an event occurs in a virtual resource.

On the other hand, time-synchronized time stamp information may be included in the space monitoring information obtained from the space monitoring unit 102 and subsequently stored in a temporary buffer or a repository, and may be processed after the lapse of a time to a degree.

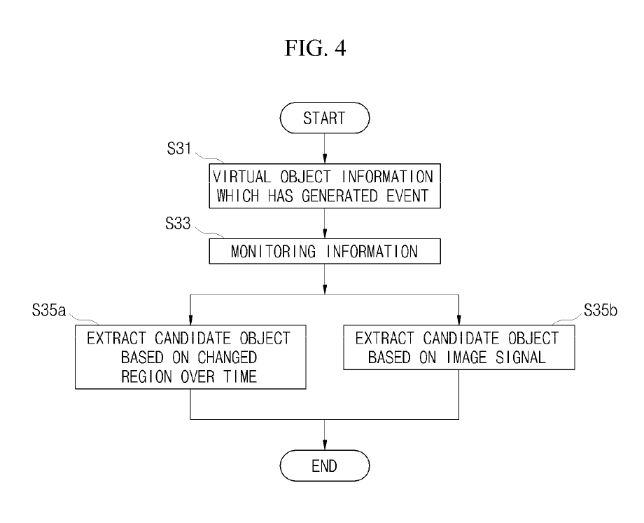

FIG. 4 is a view illustrating an object extracting method according to an embodiment of the present invention. Hereinafter, an object detecting method according to an embodiment of the present invention will be described with reference to FIG. 4.

In step S31, the object extracting unit 122 receives information such as internals state of the virtual resources which have generated the event, providing service, and the like.

In step S33, the object extracting unit 122 extracts a candidate object determined to be a virtual resource that has generated the event upon receiving an image or depth information obtained from the space monitoring unit 102.

For example, in order to detect the candidate objects, a method of using an image region changing with the passage of time (S35a) and a method of analyzing a signal included in an image (S35b) may be used.

Referring back to FIG. 3, in step S40, the object position calculating unit 123 calculates position information of each of the candidate objects output by the object extracting unit 122 in a 3D space. As described above with respect to the space monitoring unit 102, when 3D depth information is available, it may be used as the position information, and if 3D depth information is not directly available, position information may be estimated by performing an additional calculation.

In step S50, after calculating position information of each candidate object, the virtual resource position recognizing unit 124 removes candidate objects determined to have a logical error in consideration of (1) objects, (2) position information of objects, (3) characteristics of the virtual resource which has generated an event, (4) a type of event which has been generated by the virtual resource, and the like, together (S60), and determines candidate positions of the virtual resource. The determined position information of the candidate objects is regarded as a candidate position of a virtual resource and stored in the virtual resource information DB 131.

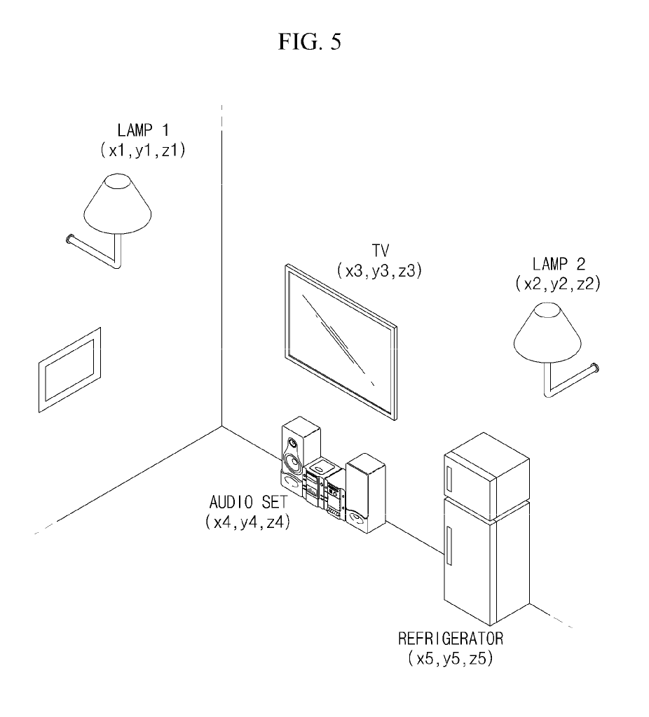

FIG. 5 is a view illustrating an example of obtaining position information by an apparatus for mapping position information of a virtual resource according to an embodiment of the present invention. Hereinafter, embodiments in which the apparatus for mapping position information of a virtual resource according to an embodiment of the present invention obtains position information will be described with reference to FIG. 5.

### Embodiment 1

### Automatically Discriminating Position of Lamp

According to the present invention, a position of a lamp may be discriminated in a space such as a house or an office. For example, it is assumed that a lamp having a function connected to a remote server and checking and controlling a state of the lamp is used. When an event that the lamp is turned on, turned off, or brightness thereof is changed occurs, the virtual resource recognizing and state information collecting unit 101 recognizes the state and obtains internal state information and the virtual resource event detecting unit 121 may detect the event which has occurred in the lamp. Here, the space monitoring unit 102 detects an object based on the monitoring information in the space and detects candidate object regions estimated as the lamp. In the example of the lamp, a region in which brightness has most considerably been changed as a candidate region. 3D space information of each of the candidate object regions is obtained, and the obtained 3D space information of the candidate objects may be mapped to the virtual resource called “lamp,” thereby achieving the aim.

### Embodiment 2

### Automatically Discriminating Position of Refrigerator

According to the present invention, a position of a refrigerator may be discriminated in a space such as a house or an office. For example, is assumed that a refrigerator having a function connected to a remote server and checking and controlling a state of the refrigerator is used. When an event that a refrigerator door is opened or closed occurs, the virtual resource recognizing and state information collecting unit 101 may recognize the state and obtain internal state information and the virtual resource event detecting unit 121 may detect the event which has occurred in the refrigerator. Here, the space monitoring unit 102 detects an object based on the monitoring information in the space and detects candidate object regions estimated as the refrigerator. In the example of the refrigerator, it is not easy to detect an object by using a change in brightness as a feature element, a method of analyzing a signal included in an image may be used together. Namely, candidate objects having a shape most similar to the refrigerator are detected by using a learned classifier.

Thereafter, 3D space information of each of the candidate object regions is obtained, and the obtained 3D space information of the candidate objects may be mapped to the virtual resource called “refrigerator,” thereby achieving the aim.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for mapping position information of a virtual resource, the method comprising:
recognizing virtual resources virtualized according to services or characteristics unique to devices in a particular space, and collecting virtual resource information including internal states and providing services of the virtual resources;
obtaining event occurrence information regarding the virtual resources by using the virtual resource information;
when an event occurs in at least any one among the virtual resources, obtaining image information regarding the particular space; and
obtaining position information regarding the virtual resources by using the event occurrence information and the image information.

2. The method of claim 1, wherein the event occurrence information includes virtual resource information of a virtual resource which has generated the event, a time at which the event has occurred, and a type of the generated event.

3. The method of claim 1, wherein the obtaining of position information comprises:
detecting candidate objects with respect to the virtual resource which has generated the event from the image information regarding the particular space;
calculating position information of each of the candidate objects; and
determining position information of the virtual resource which has generated the event by using types of the candidate objects, position information of the candidate objects, and the event occurrence information.

4. The method of claim 3, wherein the detecting of candidate objects comprises: using at least one of a method of detecting candidate objects by regarding regions in which image information including global/local brightness and a movement is changed in a time axis, as feature elements, and an object detecting method using a classifier learned based on feature elements extracted from the image information.

5. The method of claim 3, wherein the detecting of candidate objects comprises: detecting candidate objects based on feature elements extracted from the image information regarding the particular space obtained after actively controlling an operation of the virtual resource which has generated the event.

6. The method of claim 3, wherein the determining of position information comprises:
referring to position information regarding the virtual resource which has generated the event from a virtual resource information database storing position information regarding virtual resources; and
compensating for the determined position information by using the position information referred to from the virtual resource information database and a statistical filter tool such as Kalman filter or a particle filter.

7. An apparatus for mapping position information of a virtual resource, the apparatus comprising:
a virtual resource recognizing and state information collecting unit configured to recognize virtual resources virtualized according to services or characteristics unique to devices in a particular space, and collect virtual resource information including internal states and providing services of the virtual resources;
a space monitoring unit configured to obtain image information regarding the particular space when an event occurs in at least any one among the virtual resources; and
an information processing unit configured to obtain event occurrence information regarding the virtual resources by using the virtual resource information, and obtain position information regarding the virtual resources by using the event occurrence information and the image information.

8. The apparatus of claim 7, wherein the information processing unit detects candidate objects with respect to the virtual resource which has generated the event from the image information regarding the particular space, calculates position information of each of the candidate objects, and determines position information of the virtual resource which has generated the event by using types of the candidate objects, position information of the candidate objects, and the event occurrence information,
wherein when the candidate objects are detected, an operation of the virtual resource which has generated the event is actively controlled, and candidate objects are detected based on feature elements extracted from the image information regarding the particular space obtained thereafter.
